(19) United States
(12) Patent Application Publication
(10) Pub. No.: US 2026/0009188 A1
(43) Pub. Date: Jan. 8, 2026

(54) TRACK SWITCH HEATER AND CONTROL SYSTEM

(71) Applicant: Railway Equipment Company, Inc., Delano, MN (US)

(72) Inventors: DAVID K. FOX, Boca Grande, FL (US); JASON HONECK, Maple Grove, MN (US)

(21) Appl. No.: 19/259,725

(22) Filed: Jul. 3, 2025

Related U.S. Application Data
(60) Provisional application No. 63/668,627, filed on Jul. 8, 2024.

(51) Int. Cl. E01B 7/24; H05B 1/02

(52) U.S. Cl. CPC E01B 7/24; H05B 1/023

(57) ABSTRACT

A track switch heater and control circuit associated therewith, for use with a track switch is provided. The track switch heater includes a first heating element and a second heating element electrically connectable to a power source. The track switch heater further includes a heater control circuit electrically connected to the first heating element and the second heating element, the heater control circuit having an input control signal indicating a position of the track switch being in a first position or a second position. The heater control circuit independently controls power delivery from the power source to one of the first heating element or the second heating element based on the position of the track switch.

This application claims the benefit of U.S. Provisional Application 63/668,627 filed Jul. 8, 2024, the disclosure of which is incorporated by reference in its entirety.

### BACKGROUND

Track switches useable in railroads use a movable piece of track to allow trains to shift from one track to another without stopping. Track switches can be in a normal position, in which an approaching train continues without diverting to another track, or in a reverse position, which diverts an approaching train to an alternate track. A known problem with using these track switches in cold climates is that they can become inoperable when frozen or covered in snow and ice. This can negatively affect trains' ability to operate efficiently and can present safety hazards by increasing the possibility of derailments. Rail personnel sometimes need to physically clear snow and ice from track switches, which is time-consuming, costly, and dangerous. Switch heating systems are a common and superior alternative to manual removal of snow and ice from switches. These systems transfer energy, typically by conduction or radiation, to melt accumulated snow and ice from railroad switches or prevent it from accumulating, allowing the switches to operate.

### SUMMARY

In accordance with the present disclosure, the above and other issues are addressed by the following:

In a first aspect, a track switch heater system associated with a track switch includes a first heating element positionable relative to a first switch point of the track switch and electrically connectable to a power source, a second heating element positionable relative to a second switch point of the track switch and electrically connectable to the power source, and a rod heater positionable relative to a switch rod of the track switch. The track switch heater system includes a heater control circuit electrically connected to the first heating element, the second heating element and the rod heater, the heater control circuit having an input control signal indicating a position of the track switch being in a first position or a second position. During a period that the heater control circuit is activated, the heater control circuit is configured to deliver power continuously from the power source to the rod heater and to independently control power delivery from the power source to one of the first heating element or the second heating element based on a position of the track switch. In the first position of the track switch, the first switch point is in an open position and the second switch point is in a closed position, and the heater control circuit is configured to deliver power to the first heating element at a first power level greater than a power level at the second heating element. In the second position of the track switch, the first switch point is in a closed position and the second switch point is in an open position, and the heater control circuit is configured to deliver power to the second heating element at a second power level greater than a power level at the first heating element.

In a second aspect, a method of operating a track switch heater for a track switch, includes providing a track switch heater system, the system comprising: a first heating element positionable relative to a first switch point of the track switch and electrically connectable to a power source; a second heating element positionable relative to a second switch point of the track switch and electrically connectable to the power source; a third heating element positionable relative to a control rod of the track switch and electrically connectable to the power source; and a heater control circuit electrically connected to the first heating element, the second heating element, and the third heating element, the heater control circuit having an input control signal indicating a position of the track switch being in a first position or a second position, wherein in the first position the first switch point is open and the second switch point is closed, and in the second position the first switch point is closed and the second switch point is open. The method includes receiving, at the heater control circuit, the input control signal indicating the current position of the track switch, and processing the input control signal at the heater control circuit to determine whether the track switch is in the first position or the second position. The method further includes, during a period that the heater control circuit is activated, enabling power delivery continuously from the power source to the third heating element and independently controlling power delivery from the power source to one of the first heating element or the second heating element based on a position of the track switch. In the first position of the track switch the heater control circuit is configured to deliver power to the first heating element at a first power level greater than a power level at the second heating element, and in the second position of the track switch the heater control circuit is configured to deliver power to the second heating element at a second power level greater than a power level at the first heating element.

In a third aspect, a heater control system for a track switch heater associated with a track switch includes an input control signal indicating a position of the track switch being in a first position or a second position, the track switch including a first switch point and a second switch point. In the first position, the first switch point corresponds to an open switch point and the second switch point corresponds to a closed switch point. In the second position, the first switch point corresponds to the closed switch point and the second switch point corresponds to the open switch point. The heater control system includes a heater control circuit configured to receive the input control signal and an activation signal operable to activate the track switch heater, the heater control circuit generating: a first signal activating power delivery from a power source to a rod heater associated with a switch rod of the track switch; and a second signal individually controlling power delivery from the power source to one of the first switch point or the second switch point. When the track switch heater is activated, power delivered to the open switch point is greater than power delivered to the closed switch point.

In a further aspect, a heater control circuit for a track switch heater associated with a track switch includes a heater control circuit having an input control signal useable to indicate a position of the track switch being in a first position or a second position. In the first position of the track switch, a first switch point of the track switch is in an open position and a second switch point of the track switch is in a closed position, and in the second position of the track switch, the first switch point is in a closed position and the second switch point is in an open position. The heater control circuit includes a first modulating circuit electrically connectable between a power source and a first heating element, the first modulating circuit being configured to reduce power passed therethrough and being actuated in response to the track switch being in the second position, and a second modulating circuit electrically connectable between the power source and the second heating element, the second modulating circuit being configured to reduce power passed therethrough and being actuated in response to the track switch being in the first position.

### BRIEF DESCRIPTION OF THE DRAWINGS

FIG. 1 illustrates an example schematic configuration of a railroad facility having a plurality of railroad switch tracks, providing an environment in which the present application may be implemented.

FIG. 2 illustrates an example top plan view of a track switch having a switch heater installed thereon, and in which aspects of the present application may be implemented.

FIG. 3 illustrates a perspective view of a stock rail having a resistive rail heater mounted thereon.

FIG. 4 illustrates an example heater control circuit useable in conjunction with a track switch, according to a possible embodiment of the present disclosure.

FIG. 5 illustrates an example heater control circuit according to a second possible embodiment of the present disclosure.

FIG. 6 illustrates an example heater control circuit according to a third possible embodiment of the present disclosure.

FIG. 7 illustrates a flowchart of operation of a heater control circuit as described herein.

### DETAILED DESCRIPTION

In accordance with the present disclosure, in example aspects a track switch track, a track switch, a switch heater, and a heater control circuit useable with such a track switch are described. Track switches are positioned to enable rerouting of railcars onto selected rails, and include moveable guide elements including “switch points” that are positionable either adjacent to or spaced apart from stock rails. That is, a track switch includes a pair of switch points, one of which is positioned adjacent to a stock rail and the other of which is spaced apart from the opposed stock rail. The pair of switch points are movable together, via a controlling switch rod, such that when one switch point is adjacent to its nearby stock rail (at a “closed” position) the other switch point is spaced apart (at an “open” position). The switch rod may change the position to move the adjacent switch point from the closed position to an open position away from the stock rail while bringing the other switch rod from the open position to the closed position adjacent the other stock rail.

As mentioned above, ice and snow may interfere with this operation. There is particular concern with freezing, ice, and snow at the switch rod(s) as well as at the open switch point, as both may affect operation of the switch. In particular, ice or snow trapped between the rail and the “open” switch point may prevent complete closing of that switch point. There is less concern at the “closed” point, because it would not allow significant ice or snow to accumulate therebetween and prevent movement. To avoid having to manually remove ice and snow, switch heaters have been developed, which may be operational in cold or inclement weather. Such switch heaters may heat the rail and/or track switch to melt any accumulating ice or snow. Switch heaters may be implemented as a resistive heater placed adjacent to the stock rails on both sides of the railway, or may be implemented as gas blowers, or the like.

Current switch heater designs typically use a master control to turn on a heater at a switch, which activates the switch heater. The switch heater may be connected to a power source, such as a high voltage line, which provides sufficient power to generate heat and melt ice/snow. In some instances, the power source may be a power line providing alternating current (e.g., in a range of 200 VAC-5000 VAC, for example 480 VAC). When active, the heater components are configured to provide heat to both switch points as well as to the switch rod(s) used to control the positioning of the switch points. This involves significant power consumption. Furthermore, in rural areas where a railyard or other track switches may receive electricity from a rural electrical service, the railyard and switch heaters may be a significant power draw, causing voltage droop on nearby power lines.

In accordance with the present disclosure, in some instances, a control circuit for a track switch heater is provided that allows for selecting and activation of heating of different isolated portions of a track switch heater. For example, heaters that are adjacent to the two stock rails and related switch points may be individually activated based on a position of the switch points included in the track switch. In some instances, only a heater associated with a rail adjacent to a switch point in an open position is activated, while another heater associated with the opposite rail adjacent the switch point in a closed position remains deactivated. This ensures that the heater adjacent to the open switch point can melt ice/snow that may be positioned between the switch point and stock rail. When the switch points are reversed in position, the heater will reverse in operation as well, activating a heater associated with the now-open opposed switch point, and deactivating the heater associated with the now-closed switch point.

In example implementations, regardless of which switch point is open, a rod heater component of an overall track switch heater is maintained as active to ensure proper actuation of the track switch.

Overall, actuating only the rail heater at the open switch point at full power delivery has a number of advantages, particularly with respect to power consumption. Because rail heaters consume significant power, a partial or total reduction of power delivered to one of the rail heaters may provide significant cost and power savings, and have positive environmental effects.

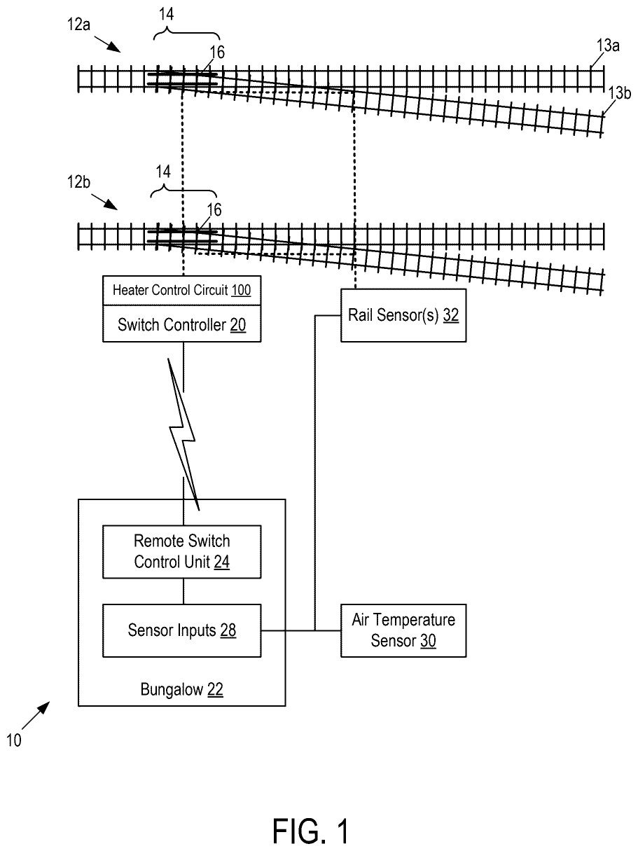

Referring now to FIG. 1, an example schematic configuration of a railroad facility 10 having a plurality of railroad switch tracks, providing an environment in which the present application may be implemented. The railroad facility as shown includes a plurality of railway tracks, including tracks 12a-b (referred to generally as tracks 12). Although two tracks are shown, it is understood that more than two may be implemented.

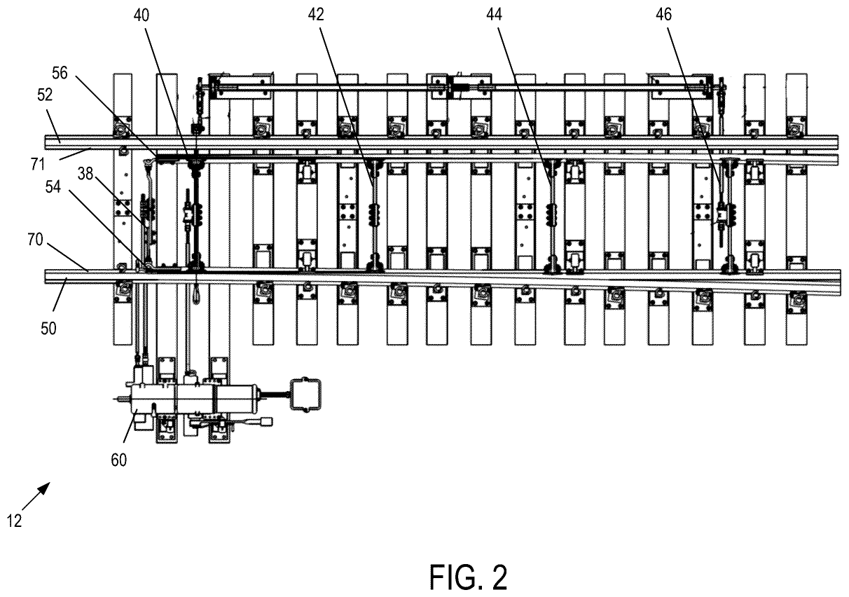

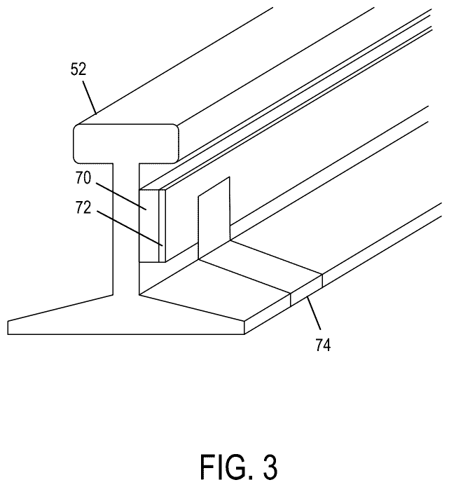

As illustrated, each of the tracks 12 includes a track switch 14, an example of which is illustrated in FIG. 2 below. Additionally, at the location of the track switch 14, each of the tracks 12 includes a track heater 16. The track heater 16 may be implemented as an electric rail heater, as illustrated schematically in FIG. 3, or may be implemented as a gas-powered blower or other type of heating element.

In the example shown, each of the track switches 14 may be controlled by a switch controller 20. As illustrated, a single switch controller 20 controls multiple track switches 14; however, in alternative implementations, a separate switch controller 20 may be associated with each track switch 14. The switch controller 20 may be configured to actuate one or more than one track switches 14 to move the track switch to a desired position. For example, the track switch 14 associated with track 12a may be configured to selectively route railcars passing along the track onto tracks 13a or 13b, depending on positioning of the track switch 14.

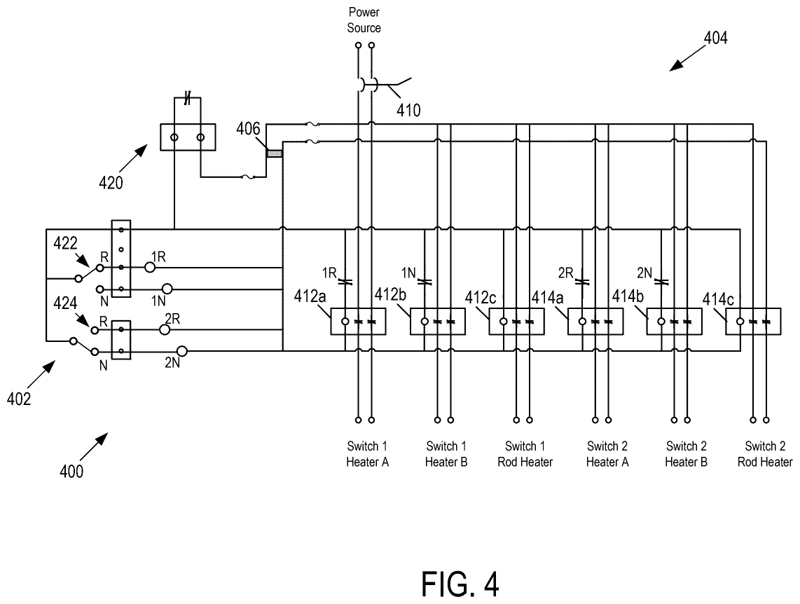

In the example as illustrated, the switch controller 20 further includes a heater control circuit 100. The heater control circuit 100 may be usable to activate one or both track heaters 16 associated with tracks 12a-b. As described further below, the heater control circuit 100 may be configured to selectively enable power delivery to generate heat individually associated with heating elements along each stock rail, rather than controlling the track heater 16 to deliver heat at both stock rails at the track switch 14. For example, the heater control circuit 100 may be configured to enable power delivery to a heating element along the stock rail associated with an open switch point, while not providing power delivery to an opposed heating element along the opposite stock rail associated with a closed switch point. In further examples, the heater control circuit 100 may be configured to reduce power delivery to a heating element associated with the closed switch point, while a higher power level is delivered to the heating element associated with the open switch point. Details regarding such an example heater control circuit are provided in conjunction with FIGS. 4-6, below.

In the example shown, the switch controller 20 is communicatively connected with a remote switch control unit 24 positioned at a bungalow 22. The bungalow 22 is located spaced apart from the switch controller 20, and generally at the same premises as the track switches 14. In the example as illustrated, the remote switch control unit 24 may be configured to communicate with the switch controller 20, for example via a wireless connection (e.g., radio frequency, Wi-Fi, or the like). The remote switch control unit 24 may remotely set positions of one or more track switches 14, and may provide a remote actuation input to the heater control circuit 100.

In the example as illustrated, the remote switch control unit 24 may set inputs to the switch controller 20 and heater control circuit 100 based at least in part on sensed conditions at the track switches 14. For example, a set of sensor inputs 28 may be received at the remote switch control unit 24, with the sensor inputs being based on an air temperature sensor 30 positioned proximate the bungalow 22 and/or tracks 12, and/or one or more rail sensors 32. The one or more rail sensors 32 may include a rail temperature sensor, a snow or ice sensor, and the like. The remote switch control unit 24 may also send signals to the switch controller 20 and heater control circuit 100 based on other data as well, for example based on train schedules, weather patterns, anticipated time required to melt snow or ice present at the tracks 12, and the like.

FIG. 2 illustrates an example top plan view of a section of track 12 at which a track switch 14 is defined. In particular, the track 12 has a switch heater installed thereon, with which aspects of the present application may be implemented. The track switch as shown includes a track with stock rails 50 and 52 positioned spaced apart and parallel with each other. As illustrated, one track switch is shown, although it is understood that more than one track switch may be implemented.

As illustrated, the track switch is connected with the stock rails 50 and 52 that define a path of the main track. The track switch also includes a switch controller 60 that may be configured to actuate the track switch to move the track switch to a desired position. The track switch also includes a pair of switch points 54 and 56, one of which 54 is positioned adjacent to a stock rail 50 and the other of which 56 is spaced apart from the opposed stock rail 52. The switch controller 60 is positioned adjacent the switch, and connects to a controlling switch rod 38 useable to move the switch between a normal position and a reversed position (referred to also as first and second positions, respectively). Specifically, the switch points 54 and 56 are movable together, in unison, via the controlling switch rod 38 such that when one switch point 54 or 56 is adjacent to its nearest stock rail (at a “closed” position) the other switch point is spaced apart (at an “open” position). The controlling switch rod 38 is operatively connected to the switch controller 60 such that the track switch can be moved to a desired position. Additional switch rods 40, 42, 44, and 46 are installed perpendicular to and across the space between the switch points 54 and 56, and are useable to guide and control the position of the switch points 54, 56. Although a specific set of switch rods are disclosed it is understood that more or fewer switch rods may be included at the track switch.

It is noted that in the case of cold weather, or the presence of ice and snow, may result in ice or snow persisting in the gap formed at the switch point in the open position—e.g., switch point 56 being spaced apart from stock rail 52—which may prevent or make difficult moving the track switch to the reversed position in which the switch point 52 is in a closed position adjacent the stock rail.

In the example shown, heating elements, shown as rail heaters 70 and 71, are installed parallel and adjacent to the stock rails 52 and 50, respectively. The heating elements in the example shown are resistive heating elements which may be mounted to the stock rails 50, 52. Other types of heating elements may be used as well; furthermore, other heating elements may be positioned adjacent the switch rods, including switch rods 38, 40, 42, 44, 46. Such heating elements may be referred to, either individually or collectively, as a rod heater associated with the switch rod(s).

FIG. 3 illustrates a perspective view of a stock rail 52 having a resistive rail heater 70 mounted thereon. Although one stock rail is shown, it is understood that more than one may be implemented.

As illustrated, the resistive rail heater 70 is mounted along the length of and parallel to the stock rail 52 and is held in place by thermal insulation 72 which is of the same height and length as the resistive rail heater 70. The thermal insulation 72 is mounted along the length of and runs parallel to the resistive rail heater 70 and to the stock rail 52. A track clip 74 holds the thermal insulation 72 and the resistive rail heater 70 securely in their place. It is understood that other means of securing the rail heater, such as adhesive or screws, may be used in place of the track clip 74 illustrated here. It is further understood that the thermal insulation 72 may be of a different size or shape than that shown in this illustration.

FIG. 4 illustrates an example heater control circuit 400 useable in conjunction with a track switch, according to a possible embodiment of the present disclosure. The heater control circuit 400 represents a possible implementation of heater control circuit 100 of FIG. 1, according to an example embodiment. In the example shown, the heater control circuit 400 has a low voltage section 402 and a high voltage section 404. The low voltage section 402 and high voltage section 404 are electrically connected via a low power transformer 406.

The high voltage section 404 includes a main breaker 410 which enables connection of a power source to the one or more switch heaters controlled by the heater control circuit. The power source may be provided as alternating current power or direct current power. In the case of alternating current power, the power source may deliver electrical power at between 200-500 VAC, for example, at 480 VAC. Such power may be received, for example, from a power substation of an electric utility. In the case of direct current power, a high direct current voltage may be used (e.g., 100 V-2 kV, for example using an approximate 600 VDC power source). Other voltages may be used as well.

In the example as illustrated, the power source is selectively connected to a switch heater at two track switches. In this context, each track switch may include three heating elements: a first heating element associated with a first stock rail and switch point; a second heating element associated with an opposed second stock rail and second, opposed switch point; and a third heating element corresponding to a rod heater positioned at a switch rod (e.g., at switch rod 38 of FIG. 2). It is understood that although two track switches are shown, the principles of the heater control circuit 400 may be used with one, three, or other numbers of track switches and related switch heaters. The two track switches are illustrated to highlight the independent operation of the two track switches with the same heater control circuit.

In the implementation shown, the high-voltage section 404 routes electrical power from the power source through contactors 412a-c, 414a-c. Contactors 412a-c are associated with a first track switch, while contactors 414a-c are associated with a second track switch. The contactors 412a-c, 414a-c may be implemented to selectively allow voltage to pass based on an input signal received on the low voltage section 404. For example, contactor 412a allows voltage to pass from the power source to a first switch heater of the first track switch (“Switch 1, Heater A”) if a first signal is received indicating that the first track switch is in a “reversed” position. Contactor 412b allows voltage to pass from the power source to a second switch heater of the first track switch (“Switch 1, Heater B”) if a second signal is received indicating that the first track switch is in a “normal” position. Contactor 412c enables power to be delivered from the power source to the rod heater of the first switch (“Switch 1, Rod Heater”) so long as a low voltage signal reaches that contactor; this may occur during the entire time the heater is activated via the low voltage section 404.

In the low voltage section 404, an activation input 420 is usable to close a circuit to activate the heater control circuit 400. That is, by closing a contact at the activation input 420, a low voltage signal (e.g., below about 30V, for example 12-24V) is allowed to pass through the low voltage section 404. A set of switch input signals, shown as switches 422, 424, are used to define the position of the switch points. Each of the switches 422, 424 may be in a “Normal” (designated as N) or “Reverse” (designated as R) position. The position of switches 422, 424 defines which control line of the low voltage section 404 is energized, leading to actuation of a relay associated with a particular switch. The relays, designated 1N, 1R, 2N, 2R for the two switches, respectively, activate contactors similarly labeled which enable low voltage signal delivery to respective contactors 412a-b or 414a-b.

In operation, when the main breaker 410 is closed and the activation input 420 is closed as well, contactors 412c, 414c are energized, delivering power to the rod heaters of both switches. Additionally, power may be individually, selectably delivered to one or the other of the heaters associated with each switch, depending on the position of the switch points. For example, when the first switch is in a Normal position, contactor 412b is energized, enabling power delivery to Heater B. Concurrently, contactor 412a remains non-energized, so power is not delivered to Heater A. When switch 422 reverses position, the energizing of heaters is reversed, with contactor 412a being energized and contactor 412b being non-energized. Similar operation of contactors 414a-b is provided as well, based on position of the switch 424.

In this way, individual rail heaters (Heaters A and B) associated with a single track switch may be individually controlled. This allows for lower power consumption, as only one rail heater and a rod heater are energized at a time.

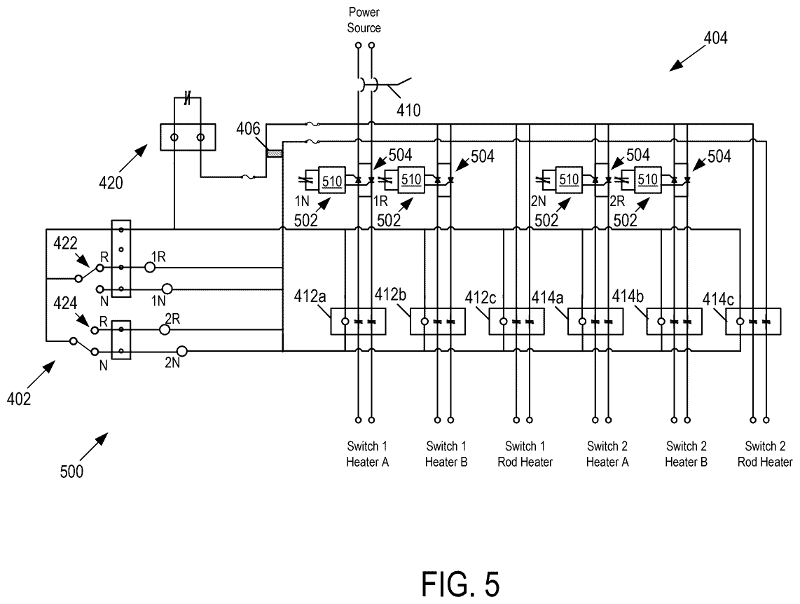

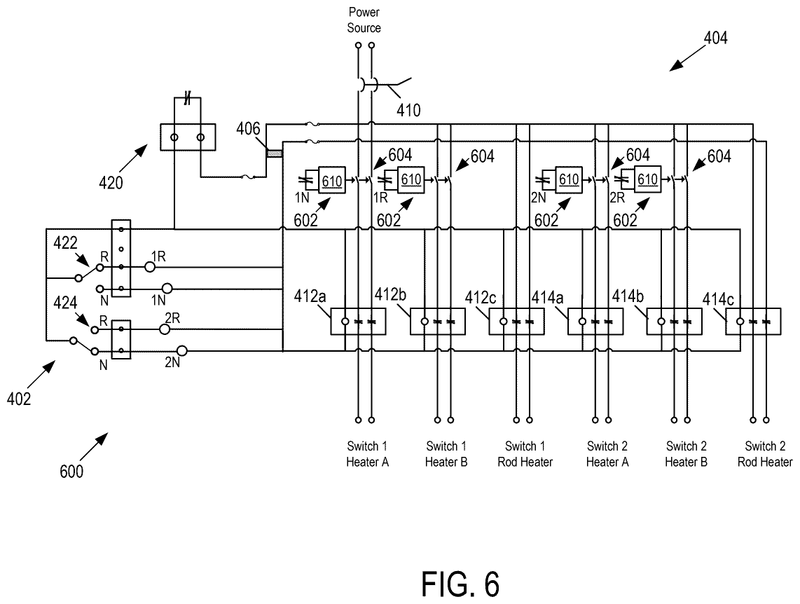

Referring to FIGS. 5-6, alternative implementations of a heater control circuit are provided. In these arrangements, the heaters associated with a single track switch may be independently controlled. In these examples, rather than selectively enabling power delivery at the contactors 412a-b, 414a-b via a contactor (e.g., contactors 1R, 1N, 2R, 2N of FIG. 4), a modulating circuit may be connected between the power source and each individual heater, and the modulating circuit may be activated by contactors to reduce power delivery to the respective heater.

In particular as illustrated in FIG. 5, a heater control circuit 500 is generally analogous to that shown in FIG. 4, but includes modulating circuits 502a-d rather than contactors that directly enable signals to energize contactors 412a-b, 414a-b as previously mentioned. The heater control circuit 500 represents a possible implementation of heater control circuit 100 of FIG. 1, according to a further example embodiment.

In this arrangement, each modulating circuit 502a-d (referred to collectively or individually as modulating circuits 502) includes a pair of silicon controlled rectifiers (SCRs) 504 positioned in opposed orientations across the high voltage signal lines between the power source and associated contactor. As such, in this embodiment, each of the modulating circuits 502a-d may be considered rectifier circuits. In each modulating circuit, a relay (shown as relays 1R, 1N, 2R, 2N, respectively) is configured to actuate a modulator 510. The modulator 510 has control outputs electrically connected to control inputs of the associated SCRs 504. The modulator 510 may be implemented as a programmable circuit, and operates to selectively actuate the SCRs, thereby selectively delivering power from the power source to the associated heater. For example, the modulator may be programmed or otherwise configured to define a duty cycle at which power may be delivered through the SCRs 504, based on defining a portion of an overall AC cycle at which the SCRs are active. By setting a lower than full duty cycle, a modulating circuit 502a-d may be operable to reduce the power delivery to a particular heater.

In this configuration, it will typically be the case that when track heaters are enabled by the breaker 410 and the activation input 420, for each associated track switch, a rod heater will be fully energized, as well as a heater associated with an open switch point. The opposite heater, associated with the closed switch point, may receive a modulated power signal, thereby receiving a lower, configurable amount of power. The contactors 412a-b, 414a-b will allow power to pass through, because the contactors are energized by way of the input control signal 420, and there is not a relay blocking the low-voltage signal input thereto; in other words, all contactors are energized concurrently in this configuration, and it is the high voltage power signal itself that is modulated at selected modulating circuits 502. This configuration therefore provides some additional configurability relative to the arrangement of FIG. 4, which as shown entirely deactivates the heater associated with a closed switch point while activating the opposite heater on the same switch, associated with the open switch point.

FIG. 6 illustrates an example heater control circuit 600 according to a third possible embodiment of the present disclosure. The heater control circuit 600 represents a possible implementation of heater control circuit 100 of FIG. 1, according to a still further alternative example embodiment. In this example, rather than SCRs 504, modulation circuits 602 associated with each rail heater includes modulator 610, which controls transistors 604. In this arrangement, the modulator 610 operates to open and close the pair of transistors 604 connected across high voltage power lines leading from the power source to the individual switch heaters. Accordingly, the modulator 610 may define a reduced amount of power to be delivered to the selected heater, based on a duty cycle or other modulation scheme that may be applied.

Comparing the arrangements of FIGS. 5-6, it is noted that the heater control circuit 600 may be utilized in circumstances where the power source is a direct current power source or an alternating current power source, while circuit 500 is best adapted for use with alternating current power due to the requirement of a zero-crossing power signal for the SCRs to properly operate. However, the operational principles of the heater control circuits 500, 600 are otherwise generally analogous.

Referring to FIGS. 5-6 generally, in addition to reducing the amount of power delivered at the closed switch point, it is noted that the modulators 510, 610 associated with each heater may be configured to change an amount of power flowing to the individual heaters over time. For example, one or more modulators 510, 610 of FIGS. 5-6 may receive as an input the activation input 420, and may initialize by allowing a relatively low level of power to be drawn by the respective heater. This may be advantageous to reduce sudden current draw by the heater system overall, which might otherwise cause voltage droop or other stress on an electrical utility service delivering power to the location at which the switch heaters are located, especially in the case where a large number of switch heaters are co-located, such as at a switching yard.

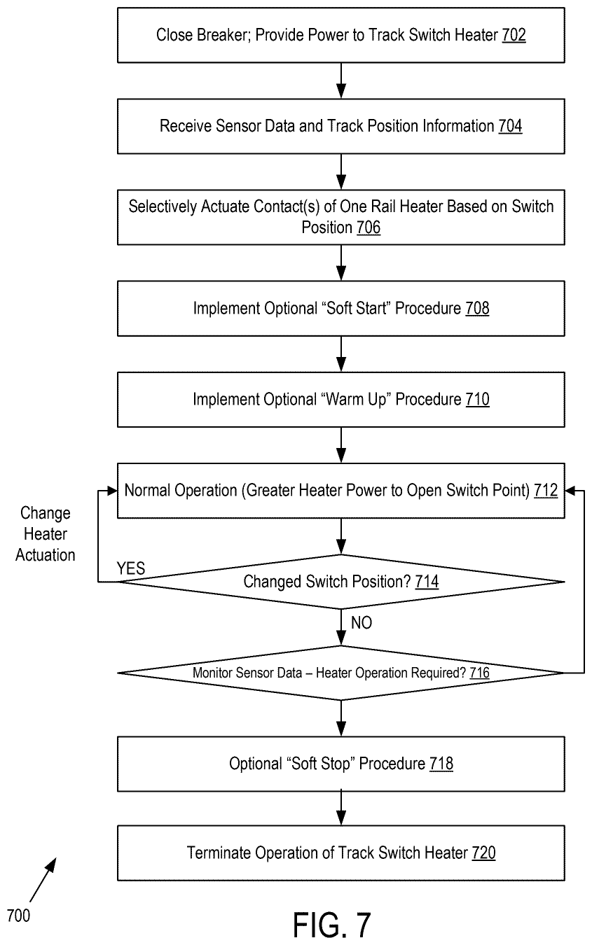

FIG. 7 illustrates a flowchart of a method 700 of operation of a heater control circuit as described herein. The method 700 may be adapted for use in conjunction with any of the heater control circuits described herein, as well as with the switch heaters and/or track switches or track switch control systems as described.

In the example shown, the method 700 includes closing a main breaker, thereby providing power to one or more track switch heaters (step 702). The main breaker may correspond to main breaker 410 described above.

In the example shown, the method 700 includes receiving sensor data and track position information (step 704). The sensor data received may include air temperature, track rail temperature, precipitation sensors, and the like. Based on the sensor data, an activation input, such as activation input 420, may be provided. The activation input may close a contactor, thereby energizing a heater control circuit as described herein (step 706).

In the example shown, the method 700 includes an optional implementation of a soft start procedure (step 708). For example, during a period of time after receipt of the activation input, in some implementations an individual portion of a switch heater (an individual heater on one of the two stock rails) may be modulated to deliver a comparatively low power level for a predetermined amount of time (e.g., between five seconds to five minutes). After a predetermined amount of time, the modulation may change to enable a higher power draw (a higher percentage duty cycle, for example). The soft start procedure may be implemented, for example using the heater control circuits 500, 600 of FIGS. 5-6. This may have the beneficial effect of reducing sudden loads on power utilities, as well as reducing wear on contactors

In some example implementations, an optional “warm up” procedure may be performed following activation and any “soft start” operations that are performed (step 710). The “warm up” procedure may include enabling power delivery to a rod heater as well as to both rail heaters of a track switch heater for a period of time, such as 15 minutes to an hour (typically in a range of 0-60 minutes). This “warm up” process may be used when ice and/or snow is present at a track switch. In example implementations, “full” power may be provided to both rail heater elements during this period, rather than delivering greater power to the open switch point as occurs during continued operation of the present heater control circuit.

In the example shown, operation proceed with “normal” operation of the heater control circuit (step 712). During normal operation of the heater control circuit, that control circuit will enable power delivery to enable heat generation at a rod heater, as well as to at least one of the two rail heater elements. In particular, a greater power level will be delivered to the rail heater element corresponding to the open switch point as compared to a power level delivered to the rail heater element corresponding to the closed switch point. In some examples, zero power will be delivered to the closed switch point, since there is not a significant need to clear ice/snow from that point because there is no space between the stock rail and the switch point (e.g., seen relative to stock rail 50 of FIG. 2). This may be the case when a heater control circuit 400 such as shown in FIG. 4 is utilized. In other examples, a lower power level will be delivered to the closed switch point, for example by modulating the power delivery to the closed switch point, as may be the case using the heater control circuits 500, 600 of FIGS. 5-6.

As illustrated, a monitoring operation (operation 714) determines a position of the track switch to determine if its position has changed. A changed position of the track switch may indicate that a first switch point, previously open, may have closed, and a second switch point, previously closed, may have opened. In this instance, if the track switch has changed positions, one or more relays may change operation, for example to change which rail heater receives a greater amount of power. For example, in response to a change in the track switch position, a previously-powered rail heater (e.g., at a switch point that was previously open and now closed) may be disconnected from power and a previously-unpowered rail heater (e.g., at a switch point that was previously closed and now open) may be provided power. If position of the switch has not changed, operation may continue with the existing power delivery configuration.

In the example shown, a sensor monitoring operation may be used to determine, for example, whether sensor data indicates that continued heater operation remains required (operation 716). For example, an air temperature sensor, snow sensor, or rail temperature sensor may be used to determine that temperatures are sufficiently high that continued heater operation is unnecessary. In that instance, operation may optionally, proceed to a “soft stop” procedure (step 718). The soft stop process may be performed using the modulating circuits of FIGS. 5-6, for example, and may be used to reduce overall power draw prior to disconnection of power entirely at contactors 412a-c, 414a-c. This can reduce wear on the contactors, prolonging life of those elements (similar to the soft start operation described above).

After completion of the soft stop procedure, or if that procedure is not used, operation of the heater control circuit may terminate (step 720), thereby disconnecting a power source from the track switch heater entirely.

If sensor data determines that rail heating operation should continue (e.g., snow or ice is detected, air temperature is sufficiently low, etc.), operation returns to step 714 to continue normal operation of the heater control circuit in accordance with the present disclosure, in which a rail heater associated with an open switch point receives greater power than the rail heater associated with the closed switch point; the rod heater stays energized throughout normal operation.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

1. A track switch heater system associated with a track switch, the track switch heater system comprising:
a first heating element positionable relative to a first switch point of the track switch and electrically connectable to a power source;
a second heating element positionable relative to a second switch point of the track switch and electrically connectable to the power source;
a rod heater positionable relative to switch rod(s) of the track switch;
a heater control circuit electrically connected to the first heating element, the second heating element and the rod heater, the heater control circuit having an input control signal indicating a position of the track switch being in a first position or a second position; and
wherein, during a period that the heater control circuit is activated, the heater control circuit is configured to deliver power continuously from the power source to the rod heater and to independently control power delivery from the power source to one of the first heating element or the second heating element based on a position of the track switch;
wherein, in the first position of the track switch, the first switch point is in an open position and the second switch point is in a closed position, and the heater control circuit is configured to deliver power to the first heating element at a first power level greater than a power level at the second heating element;
wherein, in the second position of the track switch, the first switch point is in a closed position and the second switch point is in an open position, and the heater control circuit is configured to deliver power to the second heating element at a second power level greater than a power level at the first heating element.

2. The track switch heater system of claim 1, wherein, in the first position, the power level at the second heating element is zero, and in the second position, the power level at the first heating element it zero.

3. The track switch heater system of claim 1, wherein:
based on the input control signal indicating that the track switch is in the first position, the heater control circuit actuates a contactor to a first state to deliver power to the first heating element and not to the second heating element; and
based on the input control signal indicating that the track switch is in the second position, the heater control circuit actuates a contactor to a second state to deliver power to the second heating element and not to the first heating element.

4. The track switch heater system of claim 3, wherein:
when the contactor is in the first state, the power source is disconnected from the second heating element;
when the contactor is in the second state, the power source is disconnected from the first heating element.

5. The track switch heater system of claim 1, wherein:
based on the input control signal indicating that the track switch is in the first position, the heater control circuit reduces power delivered from the power source to the second heating element without adjusting power delivery to the first heating element; and
based on the input control signal indicating that the track switch is in the second position, the heater control circuit reduces power delivered from the power source to the first heating element without adjusting power delivery to the second heating element.

6. The track switch heater system of claim 5, wherein the heater control circuit includes:
a first modulating circuit electrically connected between the power source and the first heating element, the first modulating circuit being configured to reduce power passed therethrough and being actuated in response to the track switch being in the second position; and
a second modulating circuit electrically connected between the power source and the second heating element, the second modulating circuit being configured to reduce power passed therethrough and being actuated in response to the track switch being in the first position.

7. The track switch heater system of claim 6, wherein the first modulating circuit is configured to reduce power passed therethrough to a predetermined power level, wherein the predetermined power level is adjustable.

8. The track switch heater system of claim 1, wherein the first heating element and the second heating element comprise resistive heating elements.

9. The track switch heater system of claim 1, wherein the heater control circuit includes a heater activation input.

10. The track switch heater system of claim 8, further comprising a transformer electrically connectable between the heater activation input and the power source.

11. The track switch heater system of claim 10, further comprising a main circuit breaker electrically positioned between the power source and the first and second heating elements.

12. The track switch heater system of claim 1, wherein the first heating element is positioned along a first rail adjacent to the first switch point.

13. The track switch heater system of claim 12, further comprising a communication interface configured to receive an external input control signal from an external source.

14. The track switch heater system of claim 13, wherein the external source is a control system positioned within a bungalow associated with the track switch heater, the exterior source generating the external input control signal.

15. The track switch heater system of claim 14, further comprising one or more sensors configured to detect environmental conditions and generate signal data based on the environmental conditions.

16. The track switch heater system of claim 15, wherein generation of the external input control signal is based, at least in part, on the signal data generated by the sensors electrically connected to the control system.

17. The track switch heater system of claim 16, wherein the communication interface is configured to wirelessly receive the external input control signal from the bungalow.

18. A method of operating a track switch heater for a track switch, the method comprising:
providing a track switch heater system, the system comprising:
a first heating element positionable relative to a first switch point of the track switch and electrically connectable to a power source;
a second heating element positionable relative to a second switch point of the track switch and electrically connectable to the power source;
a third heating element positionable relative to a control rod of the track switch and electrically connectable to the power source;
a heater control circuit electrically connected to the first heating element, the second heating element, and the third heating element, the heater control circuit having an input control signal indicating a position of the track switch being in a first position or a second position, wherein in the first position the first switch point is open and the second switch point is closed, and in the second position the first switch point is closed and the second switch point is open;
receiving, at the heater control circuit, the input control signal indicating the current position of the track switch;
processing the input control signal at the heater control circuit to determine whether the track switch is in the first position or the second position; and
during a period that the heater control circuit is activated, enabling power delivery continuously from the power source to the third heating element and independently controlling power delivery from the power source to one of the first heating element or the second heating element based on a position of the track switch;
wherein, in the first position of the track switch the heater control circuit is configured to deliver power to the first heating element at a first power level greater than a power level at the second heating element, and in the second position of the track switch the heater control circuit is configured to deliver power to the second heating element at a second power level greater than a power level at the first heating element.

19. The method of claim 18, wherein independently controlling power delivery from the power source to one of the first heating element or the second heating element comprises:
if the input control signal indicates that the track switch is in the first position, actuating a contactor within the heater control circuit to a first state to deliver power to the first heating element and not to the second heating element; and
if the input control signal indicates that the track switch is in the second position, actuating a contactor within the heater control circuit to a second state to deliver power to the second heating element and not to the first heating element.

20. The method of claim 18, further comprising, during the period that the heater control circuit is activated, the heater control circuit is configured to deliver power to both the first heating element and the second heating element at a same power level for a first period of time, followed by the heater control circuit being configured to deliver power to the first heating element and the second heating element based on the position of the track switch.

21. The method of claim 18, further comprising, initiating the period that the heater control circuit is activated by initiating a soft start process at the heater control circuit.

22. A heater control system for a track switch heater associated with a track switch, the heater control system comprising:
an input control signal indicating a position of the track switch being in a first position or a second position, the track switch including a first switch point and a second switch point, and wherein:
in the first position, the first switch point corresponds to an open switch point and the second switch point corresponds to a closed switch point; and
in the second position, the first switch point corresponds to the closed switch point and the second switch point corresponds to the open switch point;
a heater control circuit configured to receive the input control signal and an activation signal operable to activate the track switch heater, the heater control circuit generating:
a first signal activating power delivery from a power source to a rod heater associated with switch rod(s) of the track switch; and
a second signal individually controlling power delivery from the power source to one of the first switch point or the second switch point;
wherein, when the track switch heater is activated, power delivered to the open switch point is greater than power delivered to the closed switch point.

23. The heater control system of claim 22, further comprising:
a first contactor being actuatable to connect the power source to a first heating element associated with the first switch point of the track switch; and
a second contactor being actuatable to connect the power source to the second heating element associated with the second switch point of the track switch.

24. A heater control circuit for a track switch heater associated with a track switch, the heater control circuit comprising:
a heater control circuit having an input control signal useable to indicate a position of the track switch being in a first position or a second position, wherein, in the first position of the track switch, a first switch point of the track switch is in an open position and a second switch point of the track switch is in a closed position, and in the second position of the track switch, the first switch point is in a closed position and the second switch point is in an open position;
a first modulating circuit electrically connectable between a power source and a first heating element, the first modulating circuit being configured to reduce power passed therethrough and being actuated in response to the track switch being in the second position; and
a second modulating circuit electrically connectable between the power source and the second heating element, the second modulating circuit being configured to reduce power passed therethrough and being actuated in response to the track switch being in the first position.
